(19) United States
(12) Patent Application Publication
(10) Pub. No.: US 2013/0247400 A1
(43) Pub. Date: Sep. 26, 2013

(54) LEVELLING AND GRADING DEVICE AND SYSTEM

(71) Applicant: ANTONIO JC TRINDADE, HALTON HILLS (CA)

(72) Inventor: ANTONIO JC TRINDADE, HALTON HILLS (CA)

(21) Appl. No.: 13/674,892

(22) Filed: Nov. 12, 2012

Related U.S. Application Data
(60) Provisional application No. 61/614,505, filed on Mar. 22, 2012.

(51) Int. Cl. G01C 9/00

(52) U.S. Cl. CPC G01C 9/00
USPC 33/301; 33/329; 33/300

(57) ABSTRACT

A device comprising a level line detector selectively oriented in reference to a surface; a moveable arm; and a processor in communication with the detector and arm to selectively move the arm, to maintain the arm in surface reference. In another embodiment, a system comprising a level line detector selectively oriented in reference to a surface; a moveable arm; a processor in communication with the detector and arm to selectively move the arm, to maintain the arm in surface reference; and a level line to communicate with the detector. In another embodiment, a method comprising: selectively orienting a level line detector in reference to a surface; detecting a level line; communicating detection data to a moveable arm; and moving the arm based on the data, to maintain surface reference.

### CROSS REFERENCE TO RELATED APPLICATIONS

This Non-Provisional Utility Application claims priority from U.S. Provisional Application No. 61/614,505 filed on Mar. 22, 2012.

### FIELD OF THE INVENTION

The present invention relates to a levelling and grading device and system, and more specifically refers to maintaining a levelling or grading arm in reference to a surface, based on levelling data received.

### BACKGROUND

In grading or levelling surfaces, it is known that there is a variance from a targeted reference level (usually ground level). As a result, floors slant when they shouldn't, and don't when they should.

Industrial grading and levelling solutions require large and heavy machinery, and significant expense. Industrial accuracy cannot be translated to direct smaller consumers, because the machinery size and expense is prohibitive.

### SUMMARY OF THE INVENTION

In one embodiment, the present is a device comprising a level line detector. The detector is selectively oriented in reference to a surface. There is a moveable arm, and a processor in communication with the detector and arm to selectively move the arm. The processor is used to maintain the arm in surface reference.

In another embodiment the present is a system comprising the above, and a level line to communicate with the detector.

In another embodiment the present is a method comprising: a) selectively orienting a level line detector in reference to a surface; b) detecting a level line; c) communicating detection data to a moveable arm; d) moving the arm based on the data, to maintain surface reference.

### DRAWINGS

FIG. 1 is a perspective view of a grading and levelling device.

FIG. 2 is an alternate embodiment plan view of a grading and levelling device.

FIG. 3 is an alternate embodiment plan view of a grading and levelling device.

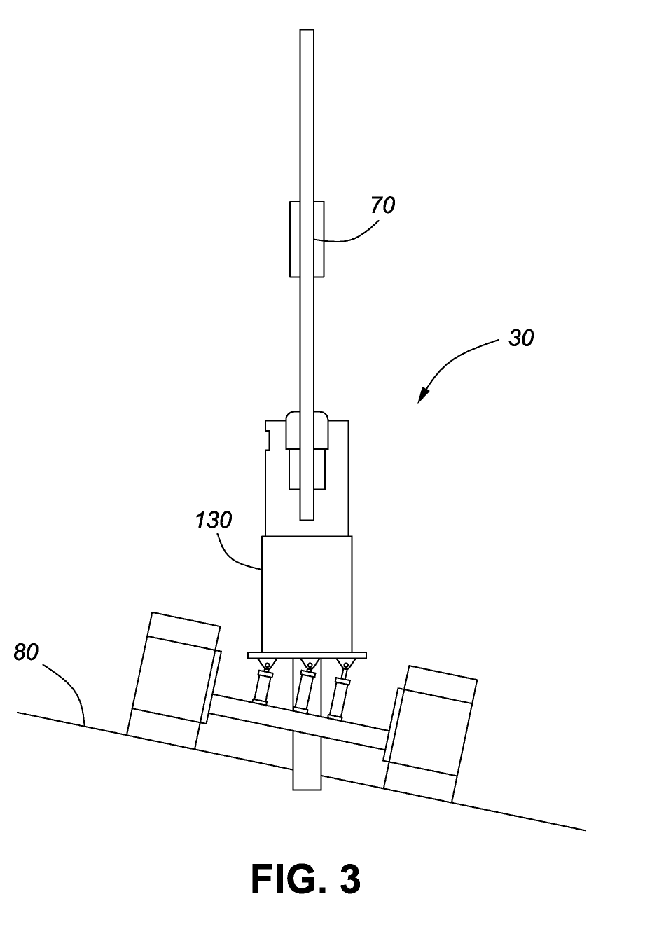

FIG. 4 is an alternate embodiment perspective view of a grading and levelling device.

FIG. 5 is an alternate embodiment plan view of a grading and levelling device.

FIG. 6 is an alternate embodiment plan view of a grading and levelling device.

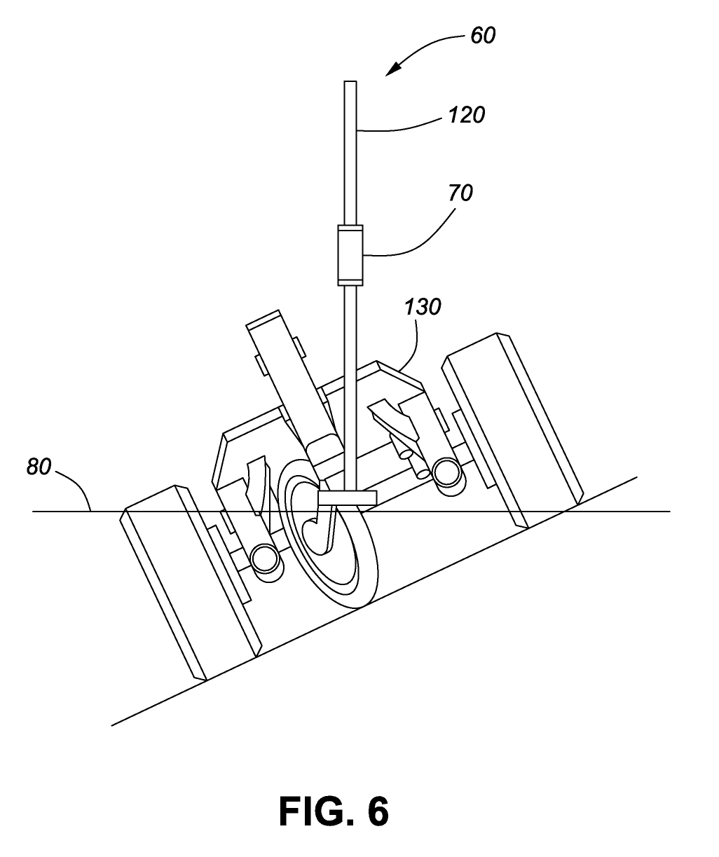

### DETAILED DRAWING DESCRIPTION

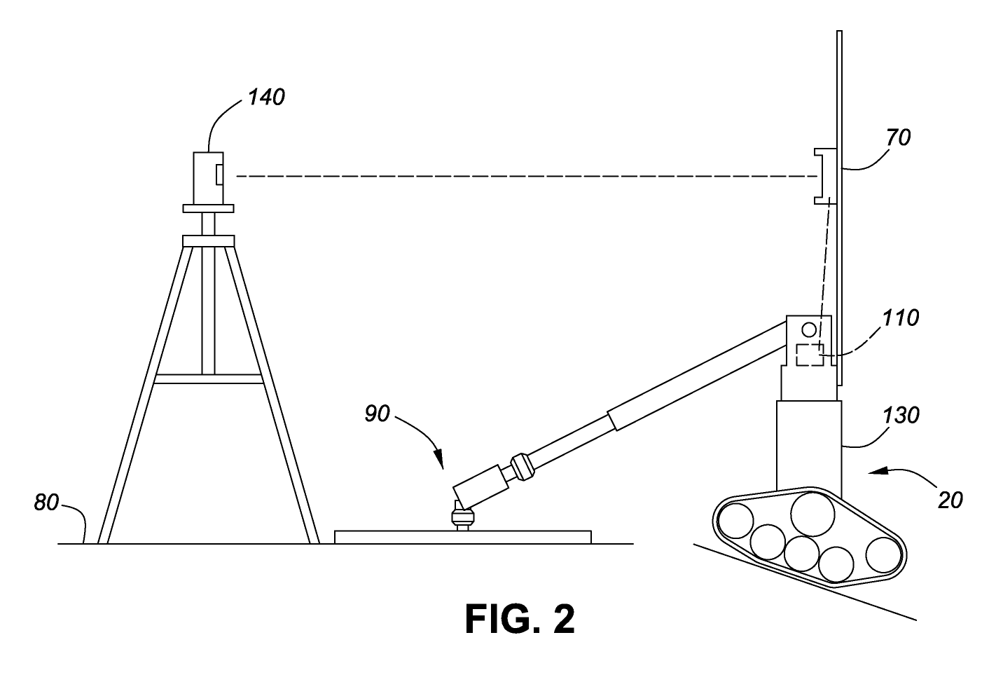

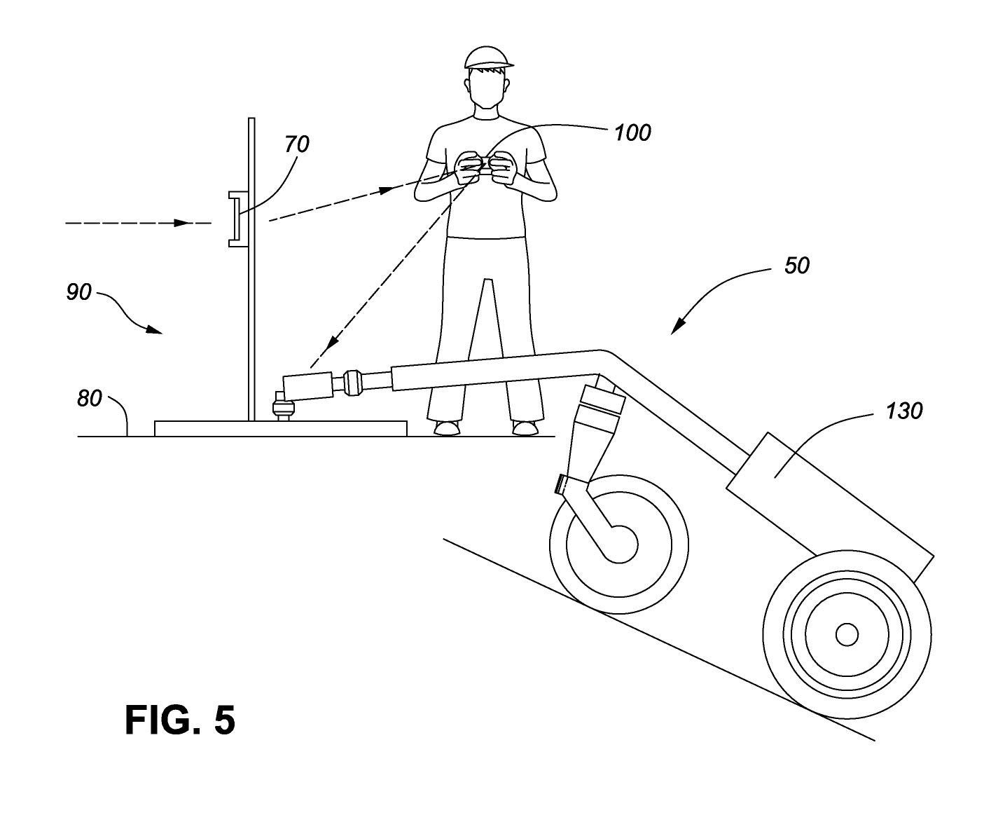

A device is indicated generally by reference numerals (10, 20, 30, 40, 50, 60, and collectively 10). The device (10) comprises a level line detector (70) selectively oriented in reference to a surface (80), and associated with a moveable arm (indicated generally by 90). A processor (for example a wireless human-operated joystick (100) in FIG. 5, and an onboard computer (110) in FIG. 2) communicates with the detector (70) and arm (90) to selectively move the arm (90), to maintain the arm (90) in surface (80) reference. The device (10) may be used for levelling or grading any of cement, sand, soil, and concrete.

Surface (80) means any of a point, plane, multiple-plane intersection, multiple-line intersection, and, can include ground level. The surface (80) can be referenced to define a point, curve, arc, angle, flat, ground level, and projecting surface.

The processor (100, 110) receives and processes data from the detector (70). Based on that data, the arm (90) is maintained in pose reference (ie maintained in reference to the surface (80) in six degrees (x-axis direction, y-axis direction, z-axis direction, pitch, yaw, and roll)). A cruder embodiment would maintain three degrees (positional) reference.

One way to orientate the device (10) is to use a gyroscope to maintain it upright relative to ground level.

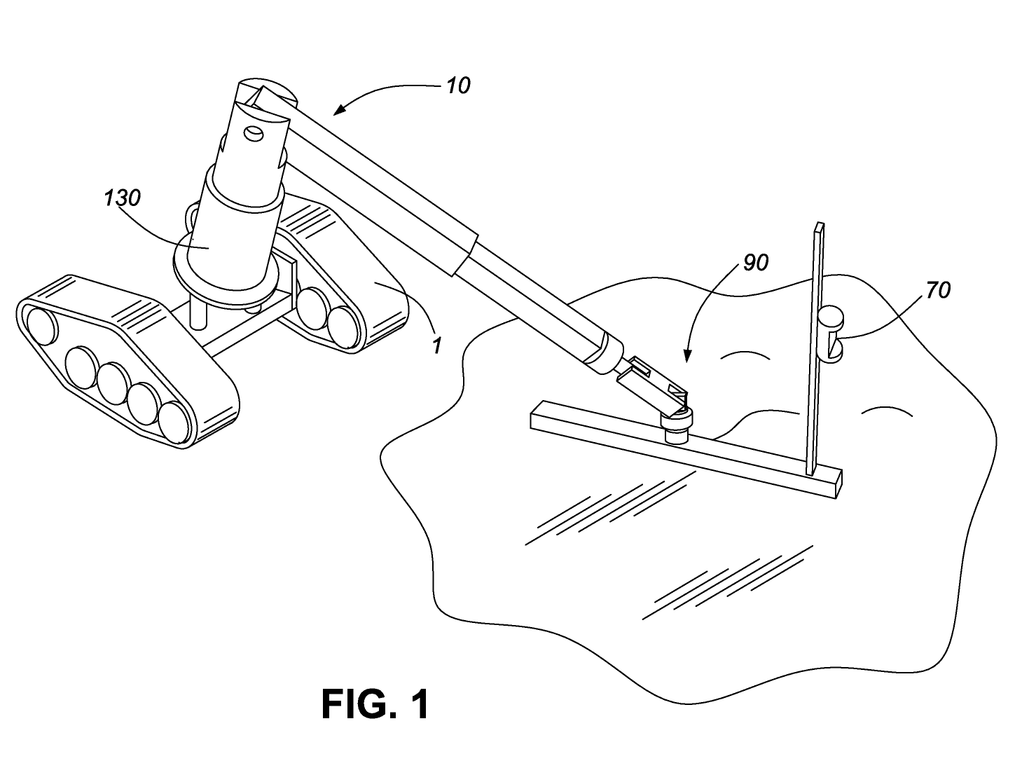

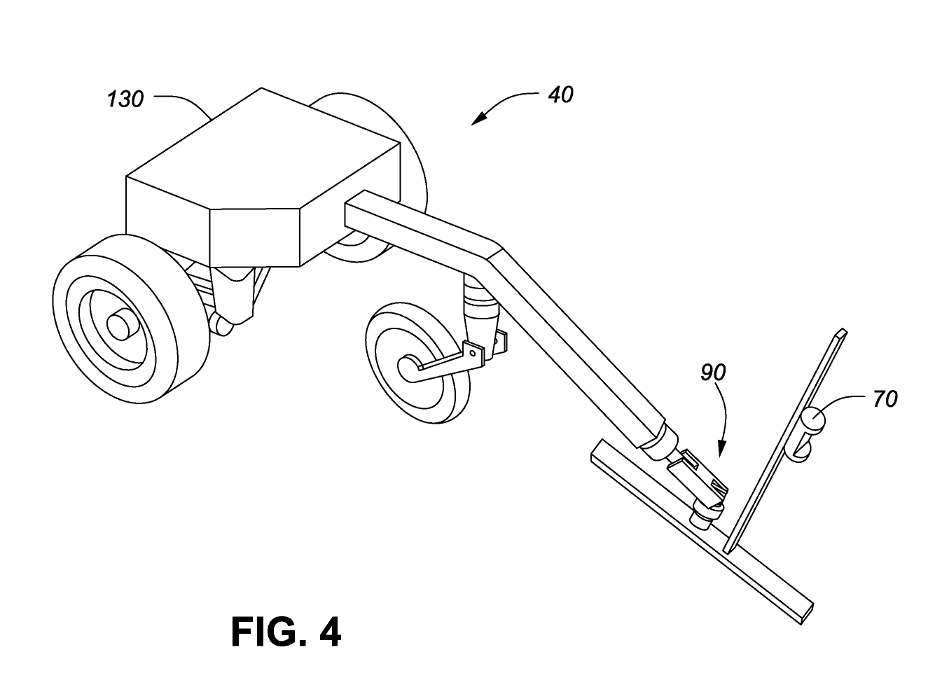

In a preferred embodiment it comprises a transport base (130) connected to any one of the arm (90) and detector (70), to move any one of the arm (90) and detector (70) over ground. The transport base can be motorized, wheeled (example FIG. 4), or tracked (example FIG. 1).

The device (10) can be deployed as a system by associating it with a level line (140) to communicate with the detector (70). In one form, the level line can be a light amplification by stimulated emission of radiation (LASER) beam. In one embodiment, such could project a level line up to 360 degrees in radius, to define a plane.

What is claimed is:

1. A device comprising a level line detector selectively oriented in reference to a surface; a moveable arm; and a processor in communication with the detector and arm to selectively move the arm, to maintain the arm in surface reference.

2. The device in claim 1 wherein the device is at least any one of a levelling and grading device for at least any one of cement, sand, soil, and concrete.

3. The device in claim 1 wherein the surface is at least any of a point, plane, multiple plane intersection, multiple line intersection, and ground level.

4. The device in claim 1 wherein the arm is maintained in any one of pose and positional reference to the surface.

5. The device in claim 1 wherein the arm is moveable in at least any one of six degrees of freedom, x-axis direction, y-axis direction, z-axis direction, pitch, yaw, and roll.

6. The device in claim 1 wherein the line detector is gyroscopically oriented.

7. The device in claim 1 further comprising a transport base connected to any one of the arm and detector, to move any one of the arm and detector over ground.

8. The device in claim 7 wherein the transport base is motorized.

9. The device in claim 7 wherein the transport base is wheeled.

10. The device in claim 7 wherein the transport base is tracked.

11. A system comprising a level line detector selectively oriented in reference to a surface; a moveable arm; a processor in communication with the detector and arm to selectively move the arm, to maintain the arm in surface reference; and a level line to communicate with the detector.

12. The system in claim 11 wherein the surface is at least any of a point, plane, multiple plane intersection, multiple line intersection, and ground level.

13. The system in claim 11 wherein the arm is maintained in any one of positional and pose reference to the surface.

14. The system in claim 11 wherein the arm is moveable in at least any one of six degrees of freedom, x-axis direction, y-axis direction, z-axis direction, pitch, yaw, and roll.

15. The system in claim 11 wherein the line detector is gyroscopically oriented.

16. The system in claim 11 wherein the level line comprises a light amplification by stimulated emission of radiation (LASER) beam.

17. The system in claim 16 wherein the LASER beams a level line up to 360 degrees in radius to define a plane.

18. The system in claim 11 further comprising a transport base connected to any one of the arm and detector, to move any one of the arm and detector over ground.

19. The system in claim 18 wherein the transport base is motorized.

20. The system in claim 18 wherein the transport base is wheeled.

21. The device in claim 18 wherein the transport base is tracked.

22. A method comprising: selectively orienting a level line detector in reference to a surface; detecting a level line; communicating detection data to a moveable arm; and moving the arm based on the data, to maintain surface reference.

23. The method in claim 22 wherein the arm is moved to at least any one of level and grade at least any one of sand, soil, concrete, and cement.

24. The method in claim 22 wherein the arm is maintained in any one of positional and pose reference to the surface.

25. The method in claim 22 wherein the arm is moveable in at least any one of six degrees of freedom, x-axis direction, y-axis direction, z-axis direction, pitch, yaw, and roll.

26. The method in claim 22 wherein the line detector is gyroscopically oriented.

27. The method in claim 22 wherein the level line comprises a LASER beam.

28. The method in claim 27 wherein the laser beams a level line up to 360 degrees in radius to define a plane.

29. The method in claim 22 further comprising processing detection data to at least any one of level and grade at least any one of sand, soil, concrete, and cement.

30. The method in claim 22 wherein the surface is any of a point, defined point, plane, defined plane, and ground level.
